(19) United States
(12) Patent Application Publication
(10) Pub. No.: US 2025/0182479 A1
(43) Pub. Date: Jun. 5, 2025

(54) SYSTEM AND METHOD FOR ACTION ANTICIPATION

(71) Applicant: Honda Motor Co., Ltd., Tokyo (JP)

(72) Inventors: Hongii GUO, Troy, NY (US); Nakul AGARWAL, San Francisco, CA (US); Kwonjoon LEE, San Jose, CA (US)

(21) Appl. No.: 18/772,738

(22) Filed: Jul. 15, 2024

Related U.S. Application Data
(60) Provisional application No. 63/604,491, filed on Nov. 30, 2023.

(51) Int. Cl. G06V 20/40; G06V 20/58; G06V 20/70

(52) U.S. Cl. CPC G06V 20/41; G06V 20/46; G06V 20/58; G06V 20/70

(57) ABSTRACT

A method for anticipating actions includes receiving video data indicating an object in an environment, encoding a noun embedding using a noun encoder based on the video data, and encoding a verb embedding with a verb encoder based on the video data. The method also includes generating a verb anticipation associated with the object in the environment by processing the noun embedding using a verb decoder, generating a noun anticipation associated with the object in the environment by processing the verb embedding using a noun decoder, and generating an action anticipation by combining the verb anticipation and the noun anticipation.

The present application claims priority to U.S. Prov. Patent App. Ser. No. 63/604,491, filed on Nov. 30, 2023, which is titled with the same inventors and is expressly incorporated herein in its entirety by reference.

### BACKGROUND

Human action anticipation aims at predicting what people will do in the future based on past and current observations. Human action anticipation is an important research topic for intelligent systems that are widely applied for autonomous driving, human-robot interaction, and smart homes.

Human action anticipation introduces challenges where future observations are unavailable and an action anticipation to be made timely for real-time purposes. Known methods for anticipating human actions often directly predict action in a verb-noun pair format in a relatively rigid and inaccurate processing structure. In this regard, under most anticipation task settings, actions are represented as verb-noun pairs which requires that both verbs and nouns be predicted correctly. Most existing methods for action anticipation tackle the task as a one-class action classification problem without considering underlying dynamics and dependencies between verbs and nouns. These methods may include models that directly output the action anticipation, which is later decomposed into verb and noun predictions in post-processing.

However, such methods have a critical drawback. If either the verb or noun of an action is difficult to predict due to limited visual cues or other information, the action can be very difficult to predict correctly since it requires both the verb and the noun to be correct, negatively impacting accuracy in action anticipation. Consequently, there is a demand for a system and method for action anticipation with processing models configured to yield more accurate action anticipations.

### BRIEF DESCRIPTION

According to one aspect, a method for anticipating actions includes receiving video data indicating an object in an environment, encoding a noun embedding using a noun encoder based on the video data, and encoding a verb embedding with a verb encoder based on the video data. The method also includes generating a verb anticipation associated with the object in the environment by processing the noun embedding using a verb decoder, generating a noun anticipation associated with the object in the environment by processing the verb embedding using a noun decoder, and generating an action anticipation by combining the verb anticipation and the noun anticipation.

According to another aspect, a system for anticipating actions in an environment includes at least one computer that receives video data indicating an object in the environment, encodes a noun embedding with a noun encoder based on the video data, and encodes a verb embedding with a verb encoder based on the video data. The at least one computer also generates a verb anticipation associated with the object in the environment by processing the noun embedding with a verb decoder, generates a noun anticipation associated with the object in the environment by processing the verb embedding with a noun decoder, and generates an action anticipation by combining the verb anticipation and the noun anticipation.

According to another aspect, a non-transitory computer readable storage medium storing instructions that, when executed by a computer having a processor, causes the processor to perform a method. The method includes receiving video data indicating an object in an environment, encoding a noun embedding using a noun encoder based on the video data, and encoding a verb embedding with a verb encoder based on the video data. The method also includes generating a verb anticipation associated with the object in the environment by processing the noun embedding using a verb decoder, generating a noun anticipation associated with the object in the environment by processing the verb embedding using a noun decoder, and generating an action anticipation by combining the verb anticipation and the noun anticipation.

### BRIEF DESCRIPTION OF THE DRAWINGS

FIG. 1 is an exemplary operating environment of an anticipation system.

FIG. 2 is a diagram of the anticipation system.

FIG. 3 is a diagram of a machine learning algorithm executed by the anticipation system.

FIG. 4 is a timeline of action anticipation performed by the anticipation system.

FIG. 5 is an extended diagram of the machine learning algorithm processing information from a feature extractor.

FIG. 6 is a table of results from an experiment including the anticipation system, using a dataset referred to as EPIC-KITCHENS-100.

FIG. 7 is a table of results from an experiment including the anticipation system, using a dataset referred to as EGTEA GAZE+.

FIG. 8 is a table of results from a third experiment including the anticipation system, using a dataset referred to as 50-Salads.

FIG. 9 is a table of results from experimentation with the anticipation system using different modalities.

FIG. 10 is a table of results from an ablation study of the anticipation system using different modalities.

FIG. 11 is a table of results from an ablation study of the anticipation system using different prediction uncertainties.

FIGS. 12A and 12B are charts comparing different types of sampling performed with the anticipation system.

FIG. 13 is a table of results from experimentation with the anticipation system using a one-stage training process and a two-stage training process.

FIG. 14 is a chart of results from an ablation study including the anticipation system, directed to top K-loss encoder loss function.

FIG. 15 is a chart of results from an ablation study including the anticipation system, directed to encoder feature loss with respect to parameters defined in the machine learning algorithm.

FIG. 16 is a table of results from experimentation with a variety of fusion methods performed using the anticipation system.

FIG. 17 is an exemplary process flow for performing action anticipation using the anticipation system.

FIG. 18 is an illustration of a computer-readable medium or computer-readable device including processor-executable instructions configured to embody one or more of the provisions set forth herein, according to one aspect.

### DETAILED DESCRIPTION

The systems and methods disclosed herein are configured to generate an action anticipation associated with an object in an environment. In this regard, an Uncertainty-aware Action Decoupling Transformer (UADT) processes features extracted from video data to generate the action anticipation. The UADT includes a verb encoder and a noun encoder that respectively receive the extracted features to encode a verb embedding and a noun embedding. The UADT also includes a noun decoder and a verb decoder that respectively receive the verb embedding and the noun embedding to generate a noun prediction and a verb prediction. The UADT may combine the embedding, the noun embedding, the noun prediction, and the verb prediction to generate the action anticipation.

### Definitions

The following includes definitions of selected terms employed herein. The definitions include various examples and/or forms of components that fall within the scope of a term and that may be used for implementation. The examples are not intended to be limiting. Furthermore, the components discussed herein, may be combined, omitted, or organized with other components or into different architectures.

“Bus,” as used herein, refers to an interconnected architecture that is operably connected to other computer components inside a computer or between computers. The bus may transfer data between the computer components. The bus may be a memory bus, a memory processor, a peripheral bus, an external bus, a crossbar switch, and/or a local bus, among others. The bus may also interconnect with components inside a device using protocols such as Media Oriented Systems Transport (MOST), Controller Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication,” as used herein, refers to a communication between two or more communicating devices (e.g., computer, personal digital assistant, cellular telephone, network device, vehicle, connected thermometer, infrastructure device, roadside equipment) and may be, for example, a network transfer, a data transfer, a file transfer, an applet transfer, an email, a hypertext transfer protocol (HTTP) transfer, and so on. A computer communication may occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), among others.

Computer communication may utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE, CAT-M, LoRa), satellite, dedicated short range communication (DSRC), among others.

“Communication interface” as used herein may include input and/or output devices for receiving input and/or devices for outputting data. The input and/or output may be for controlling different features, components, and systems. Specifically, the term “input device” includes, but is not limited to: keyboard, microphones, pointing and selection devices, cameras, imaging devices, video cards, displays, push buttons, rotary knobs, and the like. The term “input device” additionally includes graphical input controls that take place within a user interface which may be displayed by various types of mechanisms such as software and hardware-based controls, interfaces, touch screens, touch pads or plug and play devices. An “output device” includes, but is not limited to, display devices, and other devices for outputting information and functions.

“Computer-readable medium,” as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device may read.

“Database,” as used herein, is used to refer to a table. In other examples, “database” may be used to refer to a set of tables. In still other examples, “database” may refer to a set of data stores and methods for accessing and/or manipulating those data stores. In one embodiment, a database may be stored, for example, at a disk, data store, and/or a memory. A database may be stored locally or remotely and accessed via a network.

“Data store,” as used herein may be, for example, a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD ROM). The disk may store an operating system that controls or allocates resources of a computing device.

“Display,” as used herein may include, but is not limited to, LED display panels, LCD display panels, CRT display, touch screen displays, among others, that often display information. The display may receive input (e.g., touch input, keyboard input, input from various other input devices, etc.) from a user. The display may be accessible through various devices, for example, though a remote system. The display may also be physically located on a portable device or mobility device.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry may include and/or be a part of a processor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

“Memory,” as used herein may include volatile memory and/or nonvolatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

“Mobile device,” as used herein, is a computing device typically having a display screen with user input (e.g., touch, keyboard) and a processor for computing. Portable devices include, but are not limited to, handheld devices, mobile devices, smart phones, laptops, tablets, e-readers, smart speakers. In some embodiments, a “portable device” could refer to a remote device that includes a processor for computing and/or a communication interface for receiving and transmitting data remotely.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software-controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

“Operable connection,” or a connection by which entities are “operably connected,” is one in which signals, physical communications, and/or logical communications may be sent and/or received. An operable connection may include a wireless interface, firmware interface, a physical interface, a data interface, and/or an electrical interface.

“Processor,” as used herein, processes signals and performs general computing and arithmetic functions. Signals processed by the processor may include digital signals, data signals, computer instructions, processor instructions, messages, a bit, a bit stream, that may be received, transmitted and/or detected. Generally, the processor may be a variety of various processors including multiple single and multicore processors and co-processors and other multiple single and multicore processor and co-processor architectures. The processor may include logic circuitry to execute actions and/or algorithms. The processor may also include any number of modules for performing instructions, tasks, or executables.

“User” as used herein may be a biological being, such as humans (e.g., adults, children, infants, etc.).

A “wearable computing device,” as used herein may include, but is not limited to, a computing device component (e.g., a processor) with circuitry that may be worn or attached to user. In other words, a wearable computing device is a computer that is subsumed into the personal space of a user. Wearable computing devices may include a display and may include various sensors for sensing and determining various parameters of a user. For example, location, motion, and physiological parameters, among others. Exemplary wearable computing devices may include, but are not limited to, watches, glasses, clothing, gloves, hats, shirts, jewelry, rings, earrings necklaces, armbands, leashes, collars, shoes, earbuds, headphones and personal wellness devices.

### System Overview

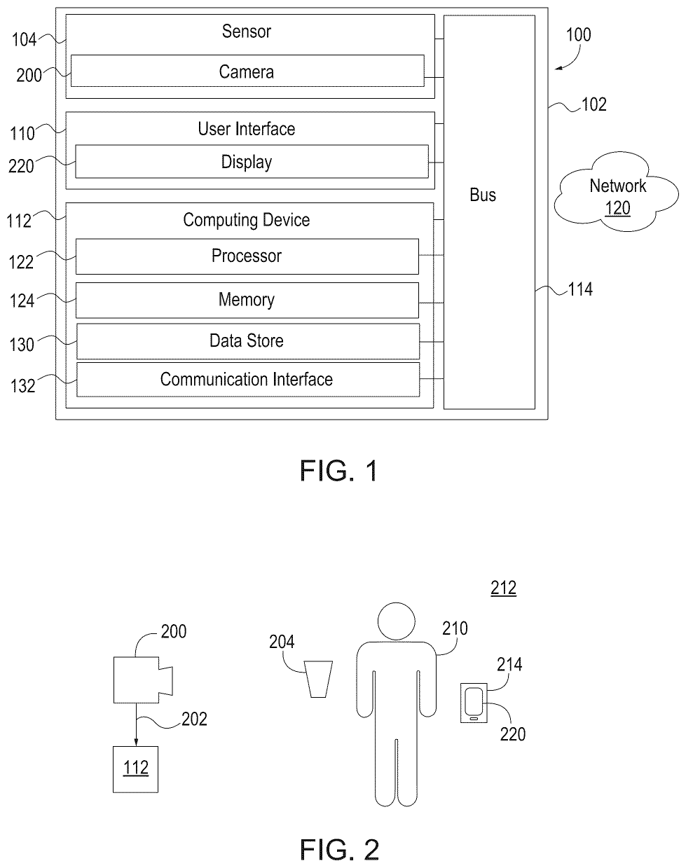

Referring now to the drawings, the drawings are for purposes of illustrating one or more exemplary embodiments and not for purposes of limiting the same. FIG. 1 is an exemplary component diagram of an operating environment 100 of an anticipation system 102 including a sensor 104, a user interface 110, and a computing device 112.

The sensor 104, the user interface 110, the computing device 112, and components thereof may be interconnected by a bus 114. The components of the operating environment 100, as well as the components of other systems, hardware architectures, and software architectures discussed herein, may be combined, omitted, or organized into different architectures for various embodiments.

The computing device 112 may be implemented as a part of the anticipation system 102 or another device, e.g., a remote server (not shown), connected via a network 120. The computing device 112 may be capable of providing wired or wireless computer communications utilizing various protocols to send and receive electronic signals internally to and from components of the operating environment 100. Additionally, the computing device 112 may be operably connected for internal computer communication via the bus 114 (e.g., a Controller Area Network (CAN) or a Local Interconnect Network (LIN) protocol bus) to facilitate data input and output between the computing device 112 and the components of the operating environment 100.

The computing device 112 includes a processor 122, a memory 124, a data store 130, and a communication interface 132, which are each operably connected for computer communication via the bus 114. The communication interface 132 provides software and hardware to facilitate data input and output between the components of the computing device 112 and other components, networks, and data sources described herein.

As shown in FIG. 2, the sensor 104 includes a camera 200 that generates video data 202 of an object 204 and a user 210 in an environment 212. The video data 202 indicates behavior by the user 210 with the object 204 in the environment 212, prior to an anticipated action. The camera 200 transmits the video data 202 to the computing device 112 for determining the anticipated action.

In an embodiment, the camera 200 transmits the video data 202 to the computing device 112 in real time. With this construction, the computing device 112 may determine the anticipated action in real time, prior to a corresponding action by the user 210.

While, as depicted, the environment 212 features the object 204 and the user 210 indicated in the video data 202, the environment 212 may additionally or alternatively feature a plurality of objects including the object 204, and a plurality of users including the user 210 captured by the camera 200. Also, while the camera 200 is a single camera supported in the environment 212, the anticipation system 102 may additionally or alternatively include a plurality of cameras that have similar features and function in a similar manner as the camera 200 for generating the video data 202 of the object 204 and the user 210. Also, the anticipation system 102 may additionally or alternatively include optical, infrared, or other cameras, light detection and ranging (LiDAR) systems, and a variety of other imaging sensors and sensor combinations as the camera 200 for generating video data 202 of the object 204 and the user 210 in the environment 212 without departing from the scope of the present disclosure.

The anticipation system 102 is configured to generate an action anticipation associated with the object 204 and the user 210 in the environment 212 based on the video data 202 captured by the camera 200. The anticipation system 102 generates the action anticipation as a verb-noun pair describing an action by the user 210 with respect to the object 204. For example, the anticipation system 102 may generate “drinking coffee” as an action anticipation based on the video data 202 generated by the camera 200 when the anticipation system 102 determines a noun identifying the object 204 is coffee, and determines behavior by the user 210 indicative of drinking a beverage.

The anticipation system 102 includes a mobile device 214 operated by the user 210. The mobile device 214 supports the user interface 110 for receiving operating instructions from the user 210 in actuating the anticipation system 102. The mobile device 214 includes a display 220 that is part of the user interface 110. The display 220 is configured to display output from the anticipation system 102, including real time action anticipations describing the user 210 interacting with the object 204. While, as depicted, the mobile device 214 is a handheld portable device operated by the user 210, the mobile device 214 may additionally or alternatively include stationary hardware, such as a remote server that communicates with the computing device 112 through the network 120, that may be operated by another user, without departing from the scope of the present disclosure.

In this regard, the anticipation system 102 may be incorporated into a variety of environments for predicting user action with respect to an object. In an exemplary embodiment, the anticipation system 102 may be incorporated into a vehicle to support autonomous features of the vehicle. In such an embodiment, the camera 200 may be mounted on the vehicle, where the camera 200 generates the video data 202 indicating the vehicle as the object 204, and indicating the user 210 in the environment 212 with the vehicle. The computing device 112 generates the action anticipation describing an action by the user 210 with respect to the vehicle as the object 204, and includes an electronic control unit (ECU) that actuates autonomous features of the vehicle based on the action anticipation.

Continuing the exemplary embodiment of the anticipation system 102 described above, the video data 202 from the camera 200 may indicate user actions inside or outside the vehicle. In this regard, the computing device 112 may determine an action anticipation describing the user 210 moving toward the vehicle while the vehicle moves along a travel route, and cause the vehicle to execute an adapted travel route to avoid collision with the user 210. The computing device 112 may determine an action anticipation describing the user 210 moving toward or away from the vehicle while the vehicle is stationary, and cause the vehicle to unlock or lock doors of the vehicle based on the action anticipation. The computing device 112 may determine an action anticipation describing the user 210 interacting with control devices inside a cabin of the vehicle, and actuate autonomous features of the vehicle, including features relating to climate control and user operation settings.

As another example, the anticipation system 102 may be incorporated into a robot configured to interact with the user 210 and the object 204, where the robot actuates autonomous features based on action anticipations. As another example, the anticipation system 102 may be incorporated into a smart home configured to interact with the user 210 and the object 204, where the smart home actuates autonomous features based on action anticipations.

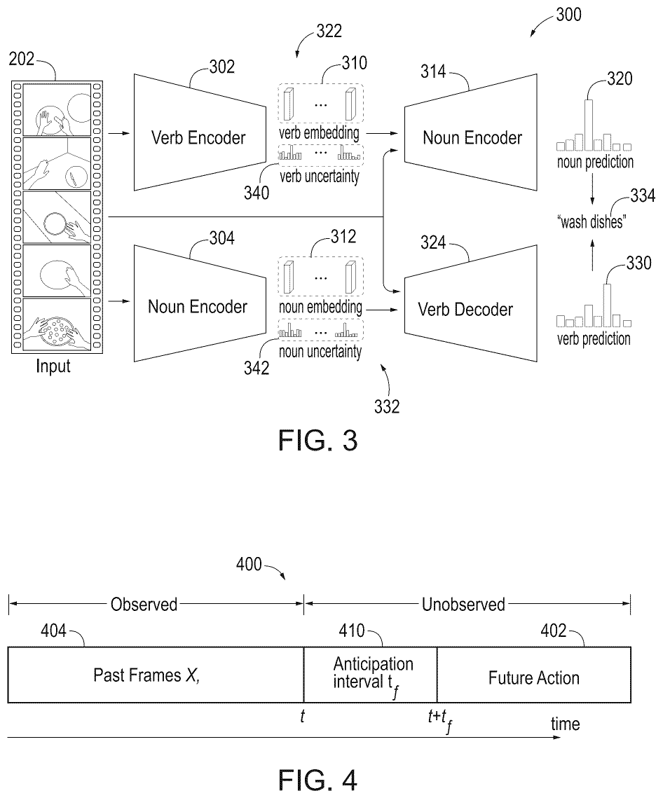

FIG. 3 depicts a machine learning algorithm 300 executed by the computing device 112 for processing the video data 202 received from the camera 200. The machine learning algorithm 300 is an uncertainty-aware action decoupling transformer (UADT) that includes a verb encoder 302 and a noun encoder 304 that receive the video data 202 indicating the object 204 and the user 210 in the environment 212. The verb encoder 302 encodes a verb embedding 310 based on the video data 202. The noun encoder 304 encodes a noun embedding 312 based on the video data 202.

The UADT also includes a noun decoder 314 that generates a noun anticipation 320 associated with the object 204 by processing the verb embedding 310. With this construction, the verb embedding 310 may be used as a prior to assist the noun decoder 314 in producing the noun anticipation 320. In this manner, the verb encoder 302 and the noun decoder 314 together form a verb-to-noun model 322 that generates the verb embedding 310 and produces the noun anticipation 320.

The UADT also includes a verb decoder 324 that generates a verb anticipation 330 associated with the object 204 in the environment 212 by processing the noun embedding 312. With this construction, the noun embedding 312 may be used as a prior to assist the verb decoder 324 in producing the verb anticipation 330. In this manner, the noun encoder 304 and the verb decoder 324 together form a noun-to-verb model 332 that generates the verb embedding 310 and produces the noun anticipation 320.

The UADT generates an action anticipation 334 by combining the noun anticipation 320 from the noun decoder 314 with the verb anticipation 330 from the verb decoder 324. In this manner, the UADT decouples the action anticipation 334 into the noun anticipation 320 and the verb anticipation 330. With this construction, a predictive uncertainty in the action anticipation 334 may be greatly reduced because the probability p ((verb, noun)|X) is converted to p (verb|X, noun) or p (noun|X, verb), where X is the input. The verb/noun information serves as a prior for the complementary part so the action anticipation 334 is simplified.

The verb encoder 302 of the verb-to-noun model 322 generates the verb embedding 310 with a corresponding verb embedding uncertainty 340. In this manner, the computing device 112 determines the verb embedding uncertainty 340 using the verb encoder 302. The verb embedding uncertainty 340 indicates a prediction confidence of verb embedding features in the verb embedding 310. The verb embedding 310 and the verb embedding uncertainty 340 are processed by the noun decoder 314 to generate the noun anticipation 320. As such, the noun anticipation 320 is augmented by the verb embedding uncertainty 340.

By quantifying a predictive uncertainty of the verb embedding 310 with the verb embedding uncertainty 340, the verb embedding uncertainty 340 may be leveraged by the noun decoder 314 to select reliable information, and filter redundancy and irrelevance from processing results. In this way, an accuracy and reliability of the verb-to-noun model 322 producing the noun anticipation 320 can be improved by benefiting from verb information.

The noun-to-verb model 332 includes a similar, inverse structure as compared to the verb-to-noun model 322. In this regard, the noun encoder 304 of the noun-to-verb model 332 generates the noun embedding 312 with a corresponding noun embedding uncertainty 342. In this manner, the computing device 112 determines the noun embedding uncertainty 342 using the noun encoder 304. The noun embedding uncertainty 342 indicates a prediction confidence of noun embedding features in the noun embedding 312.

With continued reference to FIG. 3, the noun embedding 312 and the noun embedding uncertainty 342 are processed by the verb decoder 324 to generate the verb anticipation 330. As such, the verb anticipation 330 is augmented by the noun embedding uncertainty 342. As described in greater detail below, the UADT dynamically combines the noun anticipation 320 and the verb anticipation 330 for joint action anticipation based on the corresponding predictive uncertainties.

In an embodiment, the UADT is trained in a two-stage procedure. In this regard, the verb encoder 302, the noun encoder 304, the noun decoder 314, and the verb decoder 324 are trained with different loss functions to guide each element of the UADT for a specific purpose. The verb encoder 302 and the noun encoder 304 are first trained to generate high-quality embeddings. Then, the verb encoder 302 and the noun encoder 304 are fixed to train the noun decoder 314 and the verb decoder 324 for joint action anticipation.

FIG. 4 depicts a timeline 400 of action anticipation by the computing device 112 using the machine learning algorithm 300. The goal of anticipation is to predict a future action 402 in the (verb, noun) format at time t+tᵣ based on past frames 404 denoted as Xₜ, where tᵣ is a time interval 410 before the future action happens. As such, the problem may be formulated as a classification task, represented by the following equation (1):

$${y}_{t + tf}^{*} = arg {max}_{{y}^{⋀}} p ( {y}^{⋀} t + t , \vert {X}_{t} ) \qquad ( 1 )$$

With reference to equation (1) above, y denotes an action label including the (verb, noun) format.

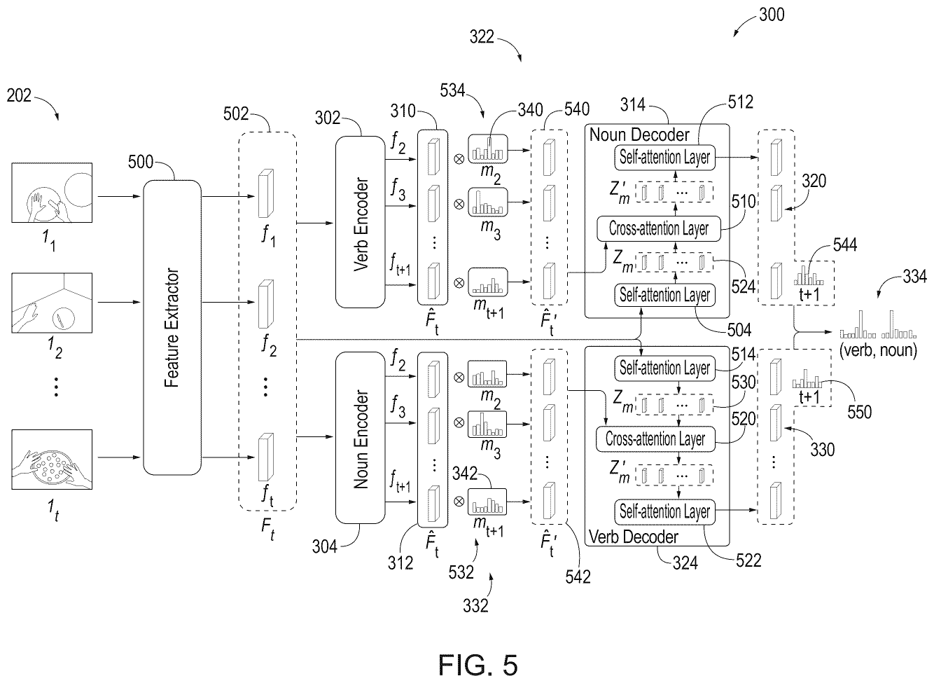

FIG. 5 depicts a detailed diagram of the machine learning algorithm 300 shown in FIG. 3, indicating a process flow of the video data 202 through the UADT. As shown in FIG. 5, the computing device 112 includes a feature extractor 500 that extracts features 502 from the past frames 404 in the video data 202 for processing by the verb encoder 302 and the noun encoder 304.

Input to the machine learning algorithm 300 at time t is denoted as Xₜ={I₁, . . . , Iₜ}, where Iₜ′ is one of the past frames 404 in the video data 202 at time f. Without a loss of generality, Xₜ may include frames sampled every k frames from the video data 202 for efficiency. This approach is acceptable because adjacent frames/often have similar action information.

The UADT architecture includes a transformer encoder design extended in a probabilistic manner configured to capture predictive uncertainty in the action anticipation 334. Specifically, the verb encoder 302 and the noun encoder 304 each include gaussian probabilistic layers as last encoder layers to model parameter distribution.

In an embodiment, training the UADT includes performing forward pass and backpropagation. As such, the UADT may generate multiple outputs based on a same input through sampling. The predictive uncertainty of the action anticipation 334 may be quantified based on the predictions generated in training the UADT.

A verb/noun-guided training strategy may be employed to respectively train the noun encoder 304 and the verb encoder 302 for generating noun-oriented embeddings and verb-oriented embeddings with respect to the noun embedding 312 and the verb embedding 310. In this regard, given the input Xₜ at time t, the feature extractor 500 is a pretrained backbone supported on the computing device 112. In an embodiment, the feature extractor 500 is a multiscale vision transformer employed as the pretrained backbone network.

The feature extractor 500 first extracts the features 502 from the video data 202, denoted as Fₜ={f₁, . . . , fₜ}. Then the verb-to-noun model 322 and the noun-to-verb model 332 respectively generate the noun anticipation 320 and the verb anticipation 330 at each time step based on Fₜ, which may be expressed as shown in the following equation (2):

$${\hat{v}}_{2} , … , {\hat{v}}_{t + 1} = VE ( {F}_{t} ) , {\hat{n}}_{2} , … , {\hat{n}}_{t + 1} = NE ( {F}_{t} ) \qquad ( 2 )$$

With reference to equation (2) above, V₊={\hat{v}₂, . . . , \hat{v}ₜ₊₁} and Nₜ={\hat{n}₂, . . . , \hat{n}ₜ₊₁} are predicted verbs and nouns. In an embodiment, the machine learning algorithm 300 is trained using a top-K cross-entropy loss so that the verb-to-noun model 322 and the noun-to-verb model 332 can tolerate certain erroneous predictions and encode more information. The loss function may be expressed as shown in the following equation (3):

$${ℒ}_{top \_ K} = \{ \begin{matrix}- log {\sum }_{k = 1}^{K} p ( {\hat{y}}_{k} ) , if top - K prediction is correct \\ - {\sum }_{c = 1}^{C} ( \hat{y} = c ) log p ( c ) , o . w .\end{matrix} \qquad ( 3 )$$

With reference to equation (3) above, Cis a total number of verb or noun classes, K is a hyper-parameter, and ŷₖ denotes the top-k predicted label. From equation (3), a classification result has less penalty if top-K predictions include the ground-truth verb/noun. In this way, the encoding space is extended to K verbs or nouns so it is more robust for wrong top-1 prediction. In the depicted embodiment, K=5 based on an ablation study described in further detail below. With this construction, the machine learning algorithm 300 avoids problems for the verb encoder 302 and the noun encoder 304 since the top-1 prediction can be wrong and the error will propagate to the noun decoder 314 and the verb decoder 324.

With continued reference to FIG. 5, the verb encoder 302 and the noun encoder 304 also produce feature anticipations at each time step for \hat{F}ₜ={\hat{f}₂, . . . , \hat{f}ₜ₊₁}, where \hat{f}ₜ is the predicted future feature of f_{T}. Specifically, the verb embedding 310 from the last layer of the verb encoder 302 is treated as a first verb anticipation, where the verb anticipation 330 generated by the verb decoder 324 is a second verb anticipation. Also, the noun embedding 312 from the last layer of the noun encoder 304 is treated as a first noun anticipation, where the verb anticipation 330 generated by the verb decoder 324 is a second noun anticipation. The verb encoder 302 and the noun encoder 304 are trained to encode the verb embedding 310 and the noun embedding 312 by minimizing the mean squared error loss L_{feat} between predicted features in the verb embedding 310 and the noun embedding 312, and true features in a self supervised manner, which may be expressed as the following equation (4):

$${ℒ}_{feat} = {‖ {F}_{t + 1} - {\hat{F}}_{t} ‖}_{2}^{2} \qquad ( 4 )$$

With reference to equation (4) above, Fₜ₊₁={f₂, . . . , fₜ₊₁}. The verb encoder 302 and the noun encoder 304 are trained separately by jointly minimizing the top-K verb/noun loss and the feature loss of the verb embedding 310 and the noun embedding 312, respectively. A total encoder loss function describing the verb encoder 302 and the noun encoder 304 of the machine learning algorithm 300 may be expressed as the following equation (5):

$${ℒ}_{en} = {ℒ}_{top \_ K}^{verb / noun} + {λℒ}_{feat} \qquad ( 5 )$$

With reference to equation (5) above, λ is a hyper-parameter that measures a weight of feature anticipation loss. After training the verb encoder 302 and the noun encoder 304, the verb embedding 310 and the noun embedding 312 output therefrom are processed by, and may be used to train the noun decoder 314 and the verb decoder 324.

The verb embedding 310 and the noun embedding 312 may contain misleading information or redundancy. To address such misleading information or redundancy, the predictive uncertainty of the verb embedding 310 and the noun embedding 312 is measured to identify a reliability in the verb embedding 310 and the noun embedding 312. Modeling the uncertainty in the verb-to-noun model 322 and the noun-to-verb model 332 is effective for action anticipation because observation of future action is unavailable, and there is intra-class ambiguity. In this regard, even same observed actions can lead to different future actions. For example, “get cup” and “pour coffee” both exist in “make coffee” and “make tea” as action anticipations. Further, different people such as the user 210 may perform a same overall action in different ways and in different orders of intermediate actions. As such, modeling predictive uncertainty in the verb-to-noun model 322 and the noun-to-verb model 332 improves accuracy and reliability in generating the action anticipation 334.

Specifically, the predictive uncertainty modeled in the depicted embodiment includes epistemic uncertainty and aleatoric uncertainty describing the verb-to-noun model 322 and the noun-to-verb model 332. Epistemic uncertainty, also known as model uncertainty, captures the lack of knowledge of model and is inversely proportional to the training data, including the video data 202. In action anticipation tasks performed using the UADT, epistemic uncertainty accounts for the unreliability of the trained model for future actions. Aleatoric uncertainty, also known as data uncertainty, measures noise in the data used to generate the action anticipation 334. This kind of uncertainty is related to a label and imperfectness of action data. The epistemic uncertainty and the aleatoric uncertainty compound into a total predictive uncertainty of the UADT. As epistemic uncertainty accounts for the internal property of the UADT model for unknowns, modeling epistemic is more effective for anticipation tasks as compared to aleatoric uncertainty.

By extending the verb encoder 302 and the noun encoder 304 in a probabilistic manner, the UADT generates a distribution of learned parameters. With this construction, the UADT may obtain N sets of parameters {θ₁, . . . , θ_{N}} by sampling and then get N predictions from the same input by repeating the forward process with different parameters. Generally, the total predictive uncertainty of the UADT is quantified as an entropy of the predictions, which may be expressed as the following equation (6):

$$ℋ [ \hat{y} \vert x ] = - {\sum }_{c = 1}^{C} p ( \hat{y} \vert x ) log p ( \hat{y} \vert x ) \qquad ( 6 )$$

With reference to equation (6) above, y is the output label and x is the input. With this, the epistemic uncertainty of the UADT may be expressed as the following equation (7):

$${𝒰}_{e} \approx ℋ [ \frac{1}{N} {\sum }_{n}^{N} p ( \hat{y} \vert x , {θ}_{N} ) ] - \frac{1}{N} {\sum }_{n}^{N} ℋ [ p ( \hat{y} \vert x , {θ}_{N} ) ] \qquad ( 7 )$$

With reference to equation (7) above, an average of N samples is used to approximate a true value since it is intractable to integrate over a parameter space. The second term on the right of equation (7) is an approximation of aleatoric uncertainty.

The same procedure is used for every time step in the UADT so that every embedding generated by the verb encoder 302 and the noun encoder 304 has a same corresponding uncertainty. In this manner, the computing device 112 determines the verb embedding uncertainty 340 as a first verb anticipation uncertainty corresponding to the verb embedding 310. Specifically, the verb embedding uncertainty 340 indicates a prediction confidence associated with the verb embedding 310 as the first verb anticipation. The computing device 112 also determines the noun embedding uncertainty 342 as a first noun anticipation uncertainty that indicates a prediction confidence associated with the noun embedding 312 as the first noun anticipation. The noun embedding uncertainty 342 indicates a prediction confidence associated with the noun embedding 312 as the first noun anticipation.

With continued reference to FIG. 5, an objective of the noun decoder 314 and the verb decoder 324 is to make the noun anticipation 320 and the verb anticipation 330 by leveraging the verb embedding 310, the noun embedding 312, the verb embedding uncertainty 340, and the noun embedding uncertainty 342. The noun decoder 314 and the verb decoder 324 also receive the extracted features 502 from the feature extractor 500.

The noun decoder 314 includes a first self-attention layer 504, a cross-attention layer 510, and a second self-attention layer 512 stacked in that order with respect to the process flow of the video data 202. The first self-attention layer 504 and the second self-attention layer 512 are transformer encoders with causal masks that ensure each step can only access past information in the video data 202. In an embodiment, the stack of the first self-attention layer 504, the cross-attention layer 510, and the second self-attention layer 512 in the noun decoder 314 have an architecture identical to the verb encoder 302.

The verb decoder 324 includes a first self-attention layer 514, a cross-attention layer 520, and a second self-attention layer 522 stacked in that order with respect to the process flow of the video data 202. The first self-attention layer 514 and the second self-attention layer 522 are transformer encoders with causal masks that ensure each step can only access past information in the video data 202. In an embodiment, the stack of the first self-attention layer 514, the cross-attention layer 520, and the second self-attention layer 522 in the verb decoder 324 have an architecture identical to the noun encoder 304.

In the process flow of the video data 202, the noun decoder 314 and the verb decoder 324 respectively receive and process the features 502 at the first self-attention layer 504, 514 to generate intermediate noun embeddings 524, denoted as Zₙₜ={zₙ₁, . . . , zₙₜ}, and intermediate verb embeddings 530 Zᵥₜ={zᵥ₁, . . . , zᵥₜ}. The intermediate noun embeddings 524 and the intermediate verb embeddings 530 are orientated to anticipate a noun and a verb respectively, which are used for cross-attention at the cross-attention layer 510, 520.

With continued reference to FIG. 5, the cross-attention layers 510, 520 respectively process the intermediate noun embeddings 524 and the intermediate verb embeddings 530 with the verb embedding 310 and the noun embedding 312 from the verb encoder 302 and the noun encoder 304. The computing device 112 applies a first uncertainty mask 532 to features of the noun embedding 312 based on the noun embedding uncertainty 342, before the noun embedding 312 is received at the cross-attention layer 520 of the verb decoder 324. The computing device 112 also applies a second uncertainty mask 534 to features of the verb embedding 310 based on the verb embedding uncertainty 340, before the verb embedding 310 is received at the cross-attention layer 510 of the noun decoder 314.

In this manner, the computing device 112 generates the verb anticipation 330 by applying the first uncertainty mask 532 to the noun embedding 312 based on the noun embedding uncertainty 342, and generates the noun anticipation by applying the second uncertainty mask 534 to the verb embedding 310 based on the verb embedding uncertainty 340. Further, the computing device 112 generates the verb anticipation 330 by receiving the extracted features 502 at the first self-attention layer 514, and receiving the noun embedding 312 at the cross-attention layer 520 included in the verb decoder 324. The computing device 112 also generates the noun anticipation 320 by receiving the extracted features 502 at the first self-attention layer 504, and receiving the verb embedding 310 at the cross-attention layer 510 included in the noun decoder 314.

The first uncertainty mask 532 and the second uncertainty mask 534 may each be expressed as Mₜ={m₂, . . . , mₜ₊₁}, and are respectively applied to select the most informative embedding from the verb encoder 302 and the noun encoder 304.

Embeddings from the verb encoder 302 and the noun encoder 304 having relatively large uncertainty tend to be less reliable and less relevant to the corresponding actions being anticipated. As such, the weights of the first uncertainty mask 532 and the second uncertainty mask 534 are inversely proportional to the determined uncertainty of the verb embedding 310 and the noun embedding 312. Specifically, the weights of the first uncertainty mask 532 and the second uncertainty mask 534 at time t may be expressed as the following equation (8):

$${m}_{{t}^{′}} = 1 - \frac{{𝒰}_{t} - {𝒰}_{m i n}}{{𝒰}_{m ax} - {𝒰}_{m i n}} \qquad ( 8 )$$

With reference to equation (8) above, [symbol] , is the epistemic uncertainty of the corresponding embedding at time t′, and [symbol] , [symbol] respectively are the maximum and the minimum epistemic uncertainty within each batch. The first uncertainty mask 532 and the second uncertainty mask are respectively multiplied to the verb embedding 310 and the noun embedding 312 at each time step to generate a weighted verb embedding 540 and a weighted noun embedding 542, denoted as \hat{F}′ₜ={m₂\hat{f}₂, . . . , mₜ₊₁\hat{f}ₜ₊₁}. A same masking procedure is used for both the verb-to-noun model 322 and the noun-to-verb model 332.

The cross-attention layer 510 in the noun decoder 314 performs cross-attention between the intermediate noun embedding Zₙₜ from the from the first self-attention layer 504 and the verb embedding 310 from the verb encoder 302. The cross-attention layer 520 in the verb decoder 324 performs cross-attention between the intermediate verb embedding Zᵥₜ from the from the first self-attention layer 514 and the noun embedding 312 from the noun encoder 304. After cross-attention is performed by the cross-attention layer 510 in the noun decoder 314, the second self-attention layer 512 of the noun decoder 304 generates the noun anticipation 320 using output from the cross-attention layer 510. After cross-attention is performed by the cross-attention layer 520 in the verb decoder 324, the second self-attention layer 522 of the verb decoder 324 generates the verb anticipation 330 using output from the cross-attention layer 520.

A cross-entropy loss function is used to train the noun decoder 314 and the verb decoder 324 at time t for generating the noun anticipation 320 and the verb anticipation 330. The cross-entropy loss function may be expressed as the following equation (9):

$${ℒ}_{next} = - log {\hat{y}}_{t} [ {c}_{t + 1} ] \qquad ( 9 )$$

With reference to equation (9) above, ŷₜ is a predicted label at time t and cₜ₊₁ is the ground-truth label of frame t+1. The computing device 112 further trains the noun decoder 314 and the verb decoder 324 for feature anticipation by minimizing £_{feat} as in equation (4).

The verb-to-noun model 322 and the noun-to-verb model 332 are trained to perform noun anticipation and verb anticipation before time t. Specifically, each output embedding goes through a linear layer to output the verb/action prediction. This sub-task is trained with a cross-entropy loss that may be expressed as the following equation (10):

$${ℒ}_{verb / noun} = - {\sum }_{τ = 1}^{t - 1} log {\hat{y}}_{τ} [ {c}_{τ + 1} ] \qquad ( 10 )$$

With reference to equation (10), ŷ_{τ} is the predicted label at time t. The total loss function for training the noun decoder 314 and the verb decoder 324 may be expressed as the following equation (11):

$${ℒ}_{de} = {ℒ}_{next} + {λ}_{1} {ℒ}_{feat} + {λ}_{2} {ℒ}_{verb / noun} \qquad ( 11 )$$

With reference to equation (11), λ₁ and λ₂ are hyper-parameters. Each of the second self-attention layers 512, 522 is extended in a probabilistic manner. As such, the noun decoder 314 and the verb decoder 324 are each configured to output predictive uncertainty corresponding to an output anticipation. With continued reference to FIG. 5, the noun decoder 314 determines a second noun anticipation uncertainty 544 that indicates a prediction confidence associated with the noun anticipation 320. The verb decoder 324 determines a second verb anticipation uncertainty 550 that indicates a prediction confidence associated with the verb anticipation 330. The second noun anticipation uncertainty 544 and the second verb anticipation uncertainty 550 respectively represent a reliability of the verb-to-noun model 322 and the noun-to-verb model 332.

An uncertainty-based fusion strategy is employed to combine predictions from the verb-to-noun model 322 and the noun-to-verb model 332 into the action anticipation 334. In this regard, predictions from the verb-to-noun model 322 and the noun-to-verb model 332 with relatively low uncertainty are more reliable, and therefore assigned higher weights for combination. A weighted fusion of the verb-to-noun model 322 and the noun-to-verb model 332 may be expressed as the following set of equations (12)-(15):

$$p ( verb ) = α {p}_{v \to n}^{en} + ( 1 - α ) {p}_{n \to v}^{de} \qquad ( 12 )$$

$$α = σ ( ( {𝒰}_{n \to v} - {𝒰}_{m i n}^{v} / {𝒰}_{m ax}^{v} - {𝒰}_{m i n}^{v} \qquad ( 13 )$$

$$p ( noun ) = β {p}_{v \to n}^{en} + ( 1 - β ) {p}_{v \to n}^{de} \qquad ( 14 )$$

$$β = σ ( ( {𝒰}_{v \to n} - {𝒰}_{m i n}^{n} / {𝒰}_{m ax}^{n} - {𝒰}_{m i n}^{n} \qquad ( 15 )$$

With reference to the set of equations (12)-(15) above, p denotes the prediction, σ represents the sigmoid function, and α and β are functions of the predictive epistemic uncertainty. In this manner, a prediction generated by the verb-to-noun model 322 and the noun-to-verb model 332 that has relatively high uncertainty is less considered in generating the action anticipation 334. The fusion is dynamic as it depends on the input uncertainty. By considering the uncertainty of future verb/noun in the decision process, the action anticipation 334 is made by the most reliable verb and noun combination.

In this manner, the computing device 112 generates the verb anticipation 330 by generating the first verb anticipation in the verb embedding 310 using the verb encoder 302, generating a second verb anticipation using the noun decoder 314, and combining the first verb anticipation with the second verb anticipation. In an embodiment, the computing device 112 combines the first verb anticipation and the second verb anticipation based on the verb embedding uncertainty 340 as the first verb anticipation uncertainty, and based on the second verb anticipation uncertainty 550.

Also, the computing device 112 generates the noun anticipation 320 by generating the first noun anticipation in the noun embedding 312 using the noun encoder 304, generating the second noun anticipation using the noun decoder 314, and combining the first noun anticipation with the second noun anticipation. In an embodiment, the computing device 112 combines the first noun anticipation and the second noun anticipation based on the noun embedding uncertainty 342 the first noun anticipation uncertainty, and based the second noun anticipation uncertainty 544.

The above-described attention fusion method of the verb-to-noun model 322 and the noun-to-verb model 332 produces the action anticipation 334. Notably, the verbs and nouns are predicted separately by the verb-to-noun model 322 and the noun-to-verb model 332. As such, some (verb, noun) pairs can be implausible such as “drinking potatoes.” To correct implausible verb-noun pairs, the computing device 112 performs post-processing by selecting a verb-noun pair from the action anticipation 334 that has the maximum joint probability among valid (verb, noun) combinations. Selection of the verb-noun pair for maximum joint probability may be expressed as the following equation (16):

$${( verb , noun )}^{*} = {arg max}_{( verb , noun ) ∈ y} p ( verb ) p ( noun ) \qquad ( 16 )$$

In this manner, the verb anticipation 330 indicates a plurality of verbs associated with the object 204, the noun anticipation 320 indicates a plurality of nouns associated with the object 204, and the computing device 112 generates the action anticipation 334 to include a verb-noun pair with a verb from the plurality of verbs and a noun from the plurality of nouns. Also, the computing device 112 generates the action anticipation 334 by selecting a verb-noun pair having a maximum joint probability among a predetermined set of valid verb-noun pairs.

With reference to equation (16) above, y is a predetermined set that contains all plausible (verb, noun) combinations. In this manner, the anticipation system 102 is configured to more reliably produce the action anticipation 334 with a plausible verb-noun pair.

Experiments including the anticipation system 102 were performed for evaluating the anticipation system 102 against previous works. The experiments respectively feature EPIC-KITCHENS-100 (EK100), EGTEA GAZE+, and 50-Salads.

EK100 is an exemplary large-scale egocentric video dataset that contains 700 cooking activity videos. EK100 features 3806 actions with 97 verbs and 300 nouns. In this experiment, the anticipation system 102 is evaluated on EK100 as the validation dataset without additional training data. The anticipation interval t_{f} in this experiment is 1 second.

EGTEA GAZE+ is an exemplary large-scale dataset for first-person-view (FPV) actions and gaze. EGTEA GAZE+ contains 28 hours cooking activity videos from 86 unique sessions of 32 subjects, and features a total of 106 actions with 19 verbs and 51 nouns. In this experiment, top-1 accuracy is used as the evaluation metric.

50-Salads is an exemplary third-person video dataset for action understanding. 50-Salads features video data of 25 people preparing 2 mixed salads in 966 activity instances. 50-Salads features a total of 17 different actions. In this experiment, top-1 action accuracy over the pre-defined splits is reported for comparison.

In the experiments, feature extraction is respectively performed on EK100, EGTEA GAZE+, and 50-Salads. For EK100, a MViTb model is employed as the feature extractor 500. A 16×4 MViTb model was pretrained on Kinetics-400 for action classification. The 16×4 model uses 16 frames sampled 4 frames apart at 30 fps, which leads to 2 seconds for each clip at 8 fps. For EGTEA Gaze+, a TSN pretrained on ImageNet-1K is used to extract features following the procedure in RULSTM. For 50-Salads, I3D features were used.

The anticipation system 102 is implemented in PyTorch, where the UADT is optimized using AdamW optimizer with momentum 0.8 and weight decay of 10⁻³. The UADT is trained for 50 epochs using a cosine scheduler with 20 warmup epochs. The batch size is set to 512. The base learning rate is set to 10⁻⁴ and end learning rate is set to 10⁻⁶. The batch size is set to 512. The dropout rate of transformer is set to 0.25. λ is set to 6 in Lₑₙ, with λ₁=5 and λ₂=0.1 in L_{de}.

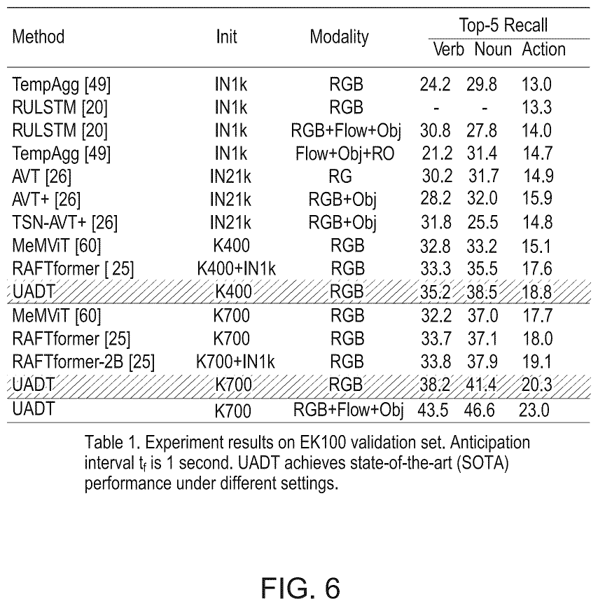

FIG. 6 depicts Table 1, which shows results from the experiment with EK100. As shown in Table 1, the anticipation system 102 outperforms the state-of-the-art RAFTformer by a large margin with both K400 and K700 features using only the RGB modality. In this manner, the UADT achieves state-of-the-art (SOTA) performance under different settings. Notably, the performance of the anticipation system 102 can be further boosted by incorporating more modalities in the ablation study, described in greater detail below.

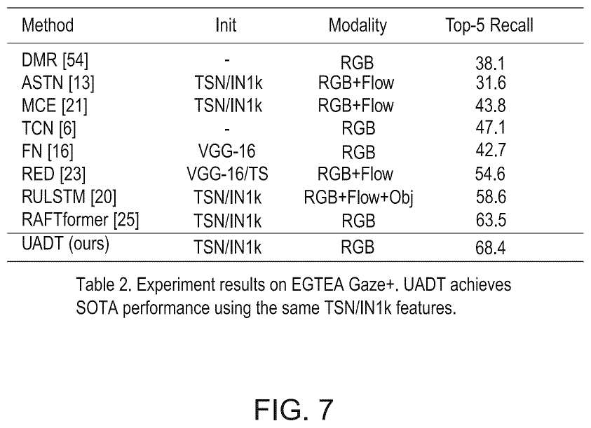

FIG. 7 depicts Table 2, which shows results from the experiment with EGTEA GAZE+. As shown in Table 2, the anticipation system 102 outperforms the RAFTformer by 4.9% using the same TSN/1N1k features. In this manner, the UADT achieves SOTA performance using the same TSN/IN1k features.

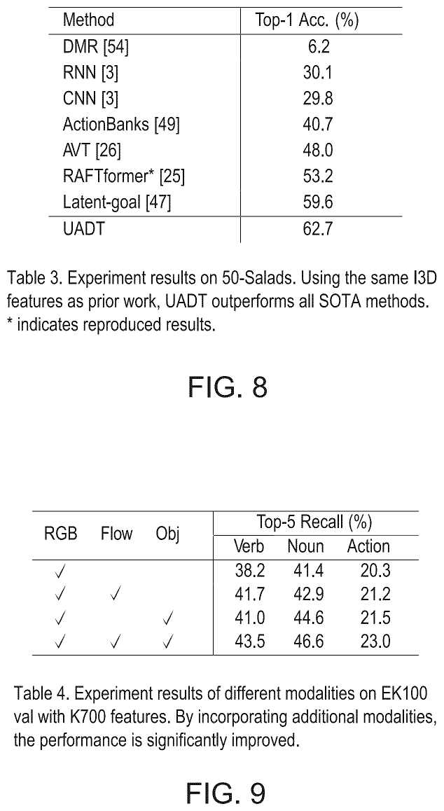

FIG. 8 depicts Table 3, which shows results from the experiment with 50-Salads. As shown in Table 3, the anticipation system 102 outperforms the Latent-goal by 3.1% using the same I3D features, demonstrating that the UADT can generalize to third-person dataset for anticipation. More broadly, the UADT outperforms all SOTA methods listed in Table 3.

The anticipation system 102 was subject to a variety of ablation studies to determine performance. In this regard, results using additional modalities including the optical flow and object features were recorded. In this regard, feature vectors of different modalities at each time are concatenated.

FIG. 9 depicts Table 4, which shows the results of using the different modalities. As compared to the results from at least Table 1, the performance of the anticipation system 102 is significantly improved by adding extra modalities. In this regard, the optical flow features significantly improve the verb anticipation since they contain motion patterns. Also, the object features are relatively effective for noun anticipation as the detected objects are highly-related to the noun of the action.

To demonstrate the effectiveness of uncertainty from the noun decoder 314 and the verb decoder 324, a baseline verb-to-noun model (VtN-b) and noun-to-verb model (NtV-b) are made without uncertainty masks. The VtN-b and the NtV-b have exactly the same architectures as the probabilistic architecture of the verb-to-noun model 322 and the noun-to-verb-model 332.

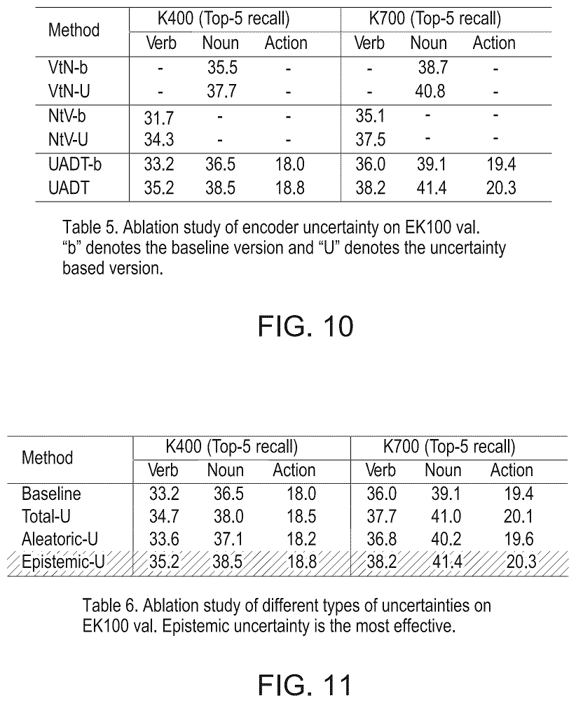

FIG. 10 depicts Table 5, which shows results comparing performance of the verb-to-noun model 322 and the noun-to-verb-model 332 against the VtN-b and the NtV-b. From the results shown in Table 5, the uncertainty-based single-stream the verb-to-noun model 322, the noun-to-verb-model 332, and UADT as a whole outperform the corresponding baseline version, demonstrating effectiveness of the verb encoder 302 and the noun encoder 304.

FIG. 11 depicts Table 6, which shows quantified epistemic uncertainty obtained using equation (5), aleatoric uncertainty obtained using equation (6), as well as the total uncertainty of the anticipation system 102. Uncertainty masks are generated based on different types of uncertainties and test the model. The baseline method is implemented in a same architecture without uncertainty modeling. From the results shown in Table 6, the epistemic uncertainty is more effective for performance by the anticipation system 102 than the other two types of uncertainties.

In the uncertainty quantification process, the forward process is repeated to obtain N predictions. The number of samples affects the accuracy of uncertainty and further affects the anticipation performance. The number of samples for different types of uncertainties was varied.

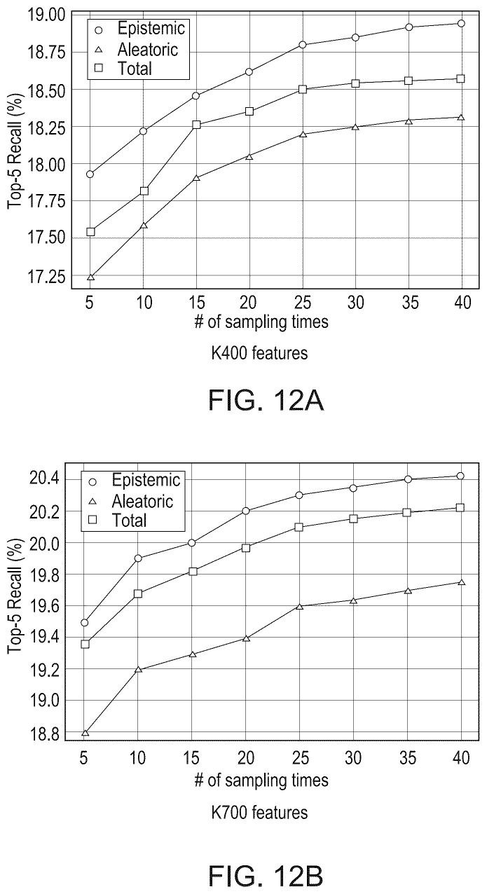

FIGS. 12A and 12B are charts depicting plots as a comparison between different types of sampling with EK100. As shown from the plots in FIGS. 12A and 12B, it takes around 25 sampling times to obtain relatively stable performance in the anticipation system 102. Also, by increasing the number of samples, the uncertainty quantification is more accurate and it further improves the anticipation.

A two-stage training mechanism was employed for training the UADT. The verb encoder 302 and the noun encoder 304 are fixed after the first stage training. Next, the noun decoder 314 and the verb decoder 324 are trained. To better optimize the verb-to-noun model 322 and the noun-to-verb-model 332 for anticipation, the verb-to-noun model 322 and the noun-to-verb-model 332 were trained in an end-to-end (E2E) manner.

Two types of E2E training were implemented, specifically a one-stage version and the two-stage version. In this regard, the one-stage E2E trains the verb encoder 302, the noun encoder 304, the noun decoder 314, and the verb decoder 324 together from scratch. For the two-stage E2E, the verb encoder 302 and the noun encoder 304 first by minimizing Lₑₙ. Next, the verb encoder 302, the noun encoder 304, the noun decoder 314, and the verb decoder 324 are jointly trained in the second stage by minimizing L_{de}.

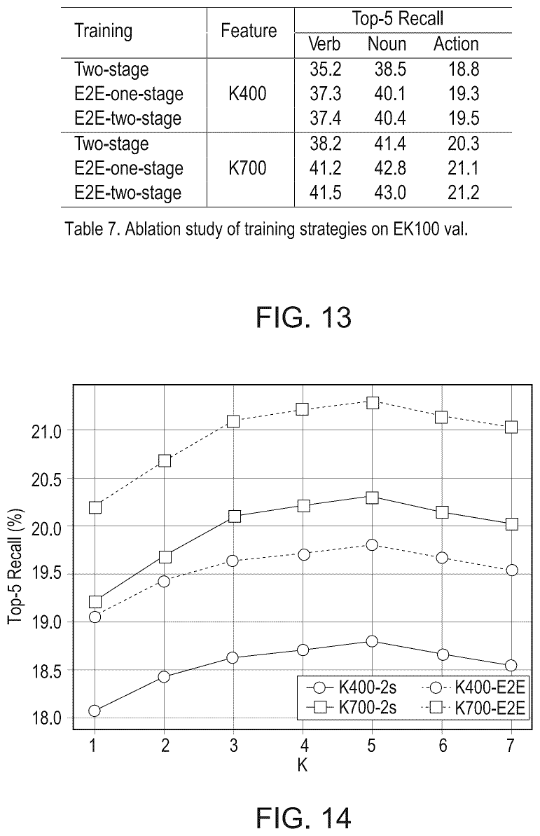

FIG. 13 depicts Table 7, which shows results from the experiment using the one-stage training process and the two-stage training process. With reference to Table 7, the end-to-end methods obtain better results because the verb encoder 302 and the noun encoder 304 are further optimized for anticipation after being trained for generating the verb embedding 310 and the noun embedding 312. Also, the two-stage E2E converges faster than the one-stage E2E since the verb encoder 302 and the noun encoder 304 are learned beforehand.

The encoder loss function Lₑₙ is composed of a top-K verb/noun loss and mean-squared error feature loss. To study the effect of K and the balance between two terms, K and A are varied during training. FIG. 14 depicts results from the experiment as an ablation study with different K values practiced on EK100. As shown in FIG. 14, the top-K loss becomes standard cross-entropy loss when K=1. As such, the results depicted in FIG. 14 also demonstrate an advantage of the top-K loss against the standard cross-entropy loss.

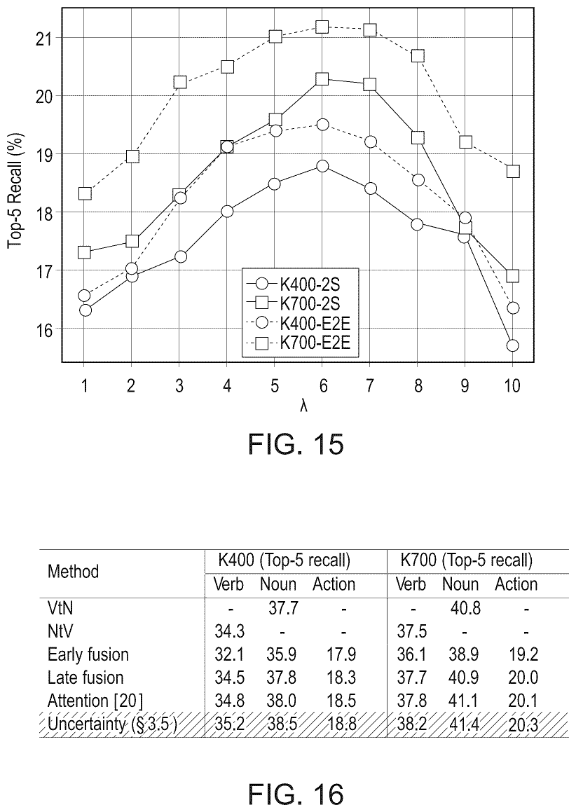

FIG. 15 depicts results plotted from the experiment as an ablation study of A. As shown in FIG. 15, K is empirically set K=5 and A=6 since these settings output best performance under different settings.

FIG. 16 depicts Table 8, which shows results from a variety of fusion methods performed using the anticipation system 102. First, an early fusion method is performed by combining predictions from the verb encoder 302 and the noun encoder 304. Second, a late fusion method is performed by combing predictions from both the verb-to-noun model 322 and the noun-to-verb model 332. Third, the attention fusion method is performed, where verb predictions from the from the verb-to-noun model 322 and the noun-to-verb model 332 are combined to generate the verb anticipation 330, and noun predictions from the verb-to-noun model 322 and the noun-to-verb model 332 are combined to generate the noun anticipation 320.

As shown in FIG. 16, the uncertainty-based fusion performed under the attention fusion method outperforms the other methods using either K400 or K700 features, which demonstrates its relative effectiveness. As such, by combining the verb-to-noun model 322 and the noun-to-verb model 332, the verb and noun predictions assist each other to improve joint action anticipation by the anticipation system 102. Notably, while the anticipation system 102 is described as directed toward performing short-term action anticipation, the anticipation system 102 may be applied for long-term action anticipation that aims at predicting a larger number of future actions. In this regard, large language models may be leveraged to further capture noun and verb dependencies.

### Methods for Action Anticipation

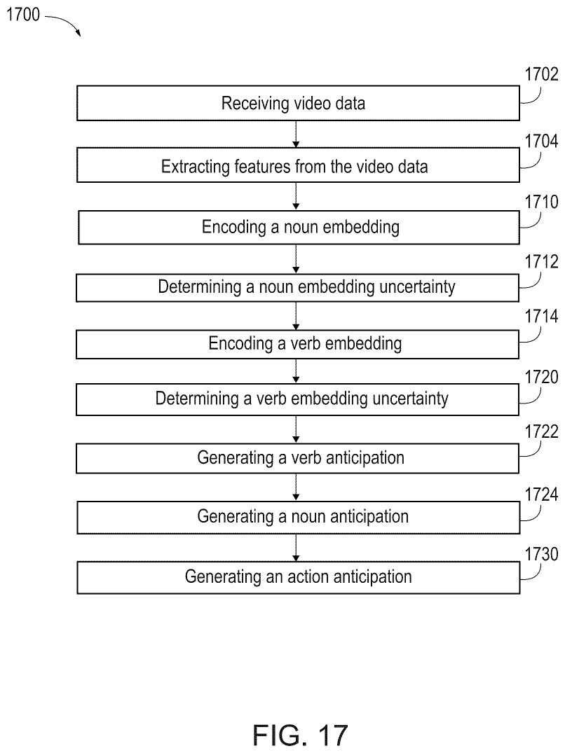

Referring to FIG. 17, an exemplary computer-implemented method for performing action anticipation with the anticipation system 102 will be described according to an exemplary embodiment. FIG. 17 will be described with reference to FIGS. 1-16. For simplicity, the method 1700 will be described as a sequence of blocks, but the elements of the method 1700 may be organized into different architectures, elements, stages, and/or processes.

At block 1702, the method 1700 includes receiving the video data 202 indicating the object 204 in the environment 212. The video data 202 is generated by the sensor 104, including the camera 200.

At block 1704, the method 1700 includes extracting features 502 from the video data 202. Extracting the features 502 from the video data 202 includes extracting the features 502 using the feature extractor 500 as a pretrained backbone network. In an embodiment, the feature extractor 500 is a multiscale vision transformer.

At block 1710, the method 1700 includes encoding the noun embedding 312 using the noun encoder 304 based on the video data 202. In an embodiment, encoding the noun embedding 312 includes encoding the extracted features 502 into the noun embedding 312.

At block 1712, the method 1700 includes determining the noun embedding uncertainty 342 using the noun encoder 304. The noun embedding uncertainty 342 indicates a prediction confidence of noun embedding features in the noun embedding 312.

At block 1714, the method 1700 includes encoding the verb embedding 310 with the verb encoder 302 based on the video data 202. In an embodiment, encoding the verb embedding 310 includes encoding the extracted features 502 into the verb embedding 310.

At block 1720, the method 1700 includes determining the verb embedding uncertainty 340 using the verb encoder 302. The verb embedding uncertainty 340 indicates a prediction confidence of verb embedding features in the verb embedding 310.

At block 1722, the method 1700 includes generating the verb anticipation 330 associated with the object 204 in the environment 212 by processing the noun embedding 312 using the verb decoder 324. In an embodiment, generating the verb anticipation 330 includes applying the first uncertainty mask 532 to the noun embedding features processed by the verb decoder 324 based on the noun embedding uncertainty 342.

Generating the verb anticipation 330 may also include receiving the extracted features 502 at the first self-attention layer 514 included in the verb decoder 324, and receiving the noun embedding features at the cross-attention layer 520 included in the verb decoder 324. Generating the verb anticipation 330 may also include processing the extracted features 502 using the first self-attention layer 514 in the verb decoder 324, and then further processing the extracted features 502 from the self-attention layer with the noun embedding 312 using the cross-attention layer 520 in the verb decoder 324. In this manner, the computing device 112 processes the noun embedding 312 and the extracted features 502 using the verb decoder 324. Generating the verb anticipation 330 may also include processing the extracted features 502 with the noun embedding 312 using a stack of at least two self-attention layers that have an architecture identical to the noun encoder 304, including the first self-attention layer 514 and the second self-attention layer 522 of the verb decoder 324.

In an embodiment, generating the verb anticipation 330 includes generating the first verb anticipation in the verb embedding 310 by processing the video data 202 using the verb encoder 302, generating the second verb anticipation by processing the verb embedding 310 using the verb decoder 324, and combining the first verb anticipation with the second verb anticipation.

Generating the verb anticipation 330 may also include determining the verb embedding uncertainty 340 as the first verb anticipation uncertainty, which indicates the prediction confidence associated with the first verb anticipation in the verb embedding 310. Generating the verb anticipation 330 may also include determining the second verb anticipation uncertainty 550, which indicates the prediction confidence associated with the second verb anticipation. Generating the verb anticipation 330 may also include combining the first verb anticipation and the second verb anticipation based on the first verb anticipation uncertainty and the second verb anticipation uncertainty 550.

At block 1724, the method 1700 includes generating the noun anticipation 320 associated with the object 204 in the environment 212 by processing the verb embedding 310 using the noun decoder 314. In an embodiment, generating the noun anticipation 320 includes applying the second uncertainty mask 534 to the verb embedding features processed by the noun decoder 314 based on the verb embedding uncertainty 340.

Generating the noun anticipation 320 may also include receiving the extracted features 502 at the first self-attention layer 504 included in the noun decoder 314, and receiving the verb embedding features at the cross-attention layer 510 included in the noun decoder 314. Generating the noun anticipation 320 may also include processing the extracted features 502 using the first self-attention layer 504 in the noun decoder 314, and then further processing the extracted features 502 from the first self-attention layer 504 with the verb embedding 310 using the cross-attention layer 510 in the verb decoder 324. In this manner, the computing device 112 processes the verb embedding 310 and the extracted features 502 using the noun decoder 314. Generating the noun anticipation 320 may also include generating processing the extracted features 502 with the verb embedding 310 using a stack of at least two self-attention layers that have an architecture identical to the verb encoder 302, including the first self-attention layer 504 and the second self-attention layer 512 of the noun decoder 314.

In an embodiment, generating the noun anticipation 320 includes generating the first noun anticipation in the noun embedding 312 by processing the video data 202 using the noun encoder 304, generating the second noun anticipation by processing the verb embedding 310 using the noun decoder 314, and combining the first noun anticipation with the second noun anticipation. Generating the noun anticipation 320 may also include determining the first noun anticipation uncertainty, which indicates the prediction confidence associated with the first noun anticipation in the noun embedding 312. Generating the noun anticipation 320 may also include determining the second noun anticipation uncertainty 544 with the noun decoder 314, which indicates the prediction confidence associated with the second noun anticipation. Generating the noun anticipation 320 may also include combining the first noun anticipation and the second noun anticipation based on the first noun anticipation uncertainty and the second noun anticipation uncertainty 544.

At block 1730, the method 1700 includes generating the action anticipation 334 by combining the verb anticipation 330 and the noun anticipation 320. In this regard, the verb anticipation 330 indicates a plurality of verbs associated with the object 204, the noun anticipation indicates a plurality of nouns associated with the object 204, and generating the action anticipation includes generating a verb-noun pair with a verb from the plurality of verbs and a noun from the plurality of nouns. Generating the action anticipation 334 includes selecting a verb-noun pair having a maximum joint probability among a predetermined set of valid verb-noun pairs.

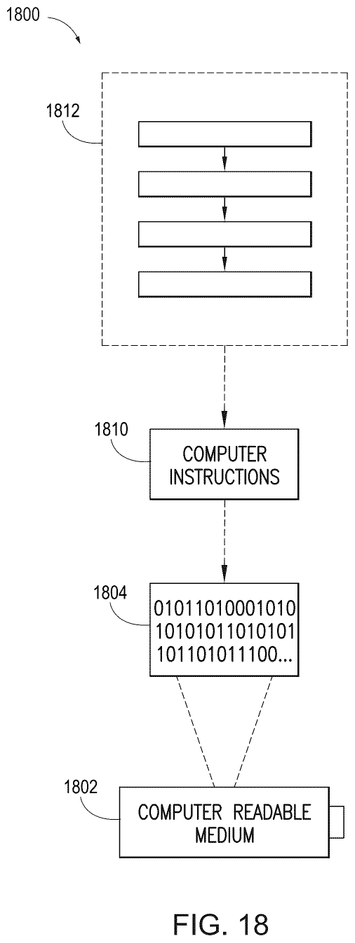

Still another aspect involves an exemplary non-transitory computer-readable medium including processor-executable instructions configured to implement one aspect of the techniques presented herein. An aspect of a computer-readable medium or a computer-readable device devised in these ways is illustrated in FIG. 18, where an implementation 1800 includes a computer-readable medium 1802, such as a CD-R, DVD-R, flash drive, a platter of a hard disk drive, etc., on which is encoded computer-readable data 1804. This encoded computer-readable data 1804, such as binary data including a plurality of zero's and one's as shown in 1804, in turn includes a set of processor-executable computer instructions 1810 configured to operate according to one or more of the principles set forth herein. In this implementation 1800, the processor-executable computer instructions 1810 may be configured to perform a method 1812, such as the method 1700 of FIG. 17. In another aspect, the processor-executable computer instructions 1810 may be configured to implement a system, such as the operating environment 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

Tables 1-8 reference citations made in provisional application 63/604,491, filed Nov. 30, 2023, which is incorporated herein by reference. The citations in the present application are made as numerals enclosed in brackets, and are disclosed in greater detail in Appendix A of provisional application 63/604,491.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A computer-implemented method for anticipating actions, the method comprising:
receiving video data indicating an object in an environment;
encoding a noun embedding using a noun encoder based on the video data;
encoding a verb embedding with a verb encoder based on the video data;
generating a verb anticipation associated with the object in the environment by processing the noun embedding using a verb decoder;
generating a noun anticipation associated with the object in the environment by processing the verb embedding using a noun decoder; and
generating an action anticipation by combining the verb anticipation and the noun anticipation.

2. The method of claim 1, further comprising:
determining a noun embedding uncertainty using the noun encoder, wherein the noun embedding uncertainty indicates a prediction confidence of noun embedding features in the noun embedding; and
determining a verb embedding uncertainty using the verb encoder, wherein the verb embedding uncertainty indicates a prediction confidence of verb embedding features in the verb embedding,
wherein generating the verb anticipation includes applying a first uncertainty mask to the noun embedding features processed by the verb decoder based on the noun embedding uncertainty, and
generating the noun anticipation includes applying a second uncertainty mask to the verb embedding features processed by the noun decoder based on the verb embedding uncertainty.

3. The method of claim 2, further comprising extracting features from the video data, wherein generating the verb anticipation includes receiving the extracted features at a self-attention layer included in the verb decoder, and receiving the noun embedding features at a cross-attention layer included in the verb decoder, and
generating the noun anticipation includes receiving the extracted features at a self-attention layer included in the noun decoder, and receiving the verb embedding features at a cross-attention layer included in the noun decoder.

4. The method of claim 1, further comprising extracting features from the video data, wherein generating the verb anticipation includes processing the noun embedding and the extracted features using the verb decoder, and generating the noun anticipation includes processing the verb embedding and the extracted features using the noun decoder.

5. The method of claim 4, wherein encoding the noun embedding includes encoding the extracted features into the noun embedding, and encoding the verb embedding includes encoding the extracted features into the verb embedding.

6. The method of claim 4, wherein extracting features from the video data includes extracting the features using a multiscale vision transformer as a pretrained backbone network.

7. The method of claim 4, wherein generating the verb anticipation includes processing the extracted features using a self-attention layer in the verb decoder, and then processing the extracted features from the self-attention layer with the noun embedding using a cross-attention layer in the verb decoder, and
generating the noun anticipation includes processing the extracted features using a self-attention layer in the noun decoder, and then processing the extracted features from the self-attention layer with the verb embedding using a cross-attention layer in the verb decoder.

8. The method of claim 4, wherein generating the verb anticipation includes processing the extracted features with the noun embedding using a stack of at least two self-attention layers that have an architecture identical to the noun encoder, and
generating the noun anticipation includes processing the extracted features with the verb embedding using a stack of at least two self-attention layers that have an architecture identical to the verb encoder.

9. The method of claim 1, wherein:
generating the verb anticipation includes generating a first verb anticipation by processing the video data using the verb encoder, generating a second verb anticipation by processing the verb embedding using the verb decoder, and combining the first verb anticipation with the second verb anticipation, and
generating the noun anticipation includes generating a first noun anticipation by processing the video data using the noun encoder, generating a second noun anticipation by processing the verb embedding using the noun decoder, and combining the first noun anticipation with the second noun anticipation.

10. The method of claim 9, further comprising:
determining a first verb anticipation uncertainty that indicates a prediction confidence associated with the first verb anticipation;
determining a second verb anticipation uncertainty that indicates a prediction confidence associated with the second verb anticipation;
determining a first noun anticipation uncertainty that indicates a prediction confidence associated with the first noun anticipation; and
determining a second noun anticipation uncertainty that indicates a prediction confidence associated with the second noun anticipation,
wherein the first verb anticipation and the second verb anticipation are combined based on the first verb anticipation uncertainty and the second verb anticipation uncertainty, and
the first noun anticipation and the second noun anticipation are combined based on the first noun anticipation uncertainty and the second noun anticipation uncertainty.

11. The method of claim 1, wherein the verb anticipation indicates a plurality of verbs associated with the object, the noun anticipation indicates a plurality of nouns associated with the object, and generating the action anticipation includes generating a verb-noun pair with a verb from the plurality of verbs and a noun from the plurality of nouns.

12. The method of claim 11, wherein generating the action anticipation includes selecting a verb-noun pair having a maximum joint probability among a predetermined set of valid verb-noun pairs.

13. A system for anticipating actions in an environment, the system comprising at least one computer that:
receives video data indicating an object in the environment;
encodes a noun embedding with a noun encoder based on the video data;
encodes a verb embedding with a verb encoder based on the video data;
generates a verb anticipation associated with the object in the environment by processing the noun embedding with a verb decoder;
generates a noun anticipation associated with the object in the environment by processing the verb embedding with a noun decoder; and
generates an action anticipation by combining the verb anticipation and the noun anticipation.

14. The system of claim 13, wherein the at least one computer:
determines a noun embedding uncertainty using the noun encoder, wherein the noun embedding uncertainty indicates a prediction confidence of noun embedding features in the noun embedding;
determines a verb embedding uncertainty using the verb encoder, wherein the verb embedding uncertainty indicates a prediction confidence of verb embedding features in the verb embedding;
generates the verb anticipation by applying a first uncertainty mask to the noun embedding features based on the noun embedding uncertainty, and
generates the noun anticipation by applying a second uncertainty mask to the verb embedding features based on the verb embedding uncertainty.

15. The system of claim 14, wherein the at least one computer:
extracts features from the video data;
generates the verb anticipation by receiving the extracted features at a self-attention layer included in the verb decoder, and receiving the noun embedding features at a cross-attention layer included in the verb decoder; and
generates the noun anticipation by receiving the extracted features at a self-attention layer included in the noun decoder, and receiving the verb embedding features at a cross-attention layer included in the noun decoder.

16. The system of claim 13, wherein the at least one computer:
generates the verb anticipation by generating a first verb anticipation using the verb encoder, generating a second verb anticipation using the noun decoder, and combining the first verb anticipation with the second verb anticipation, and
generates the noun anticipation by generating a first noun anticipation using the noun encoder, generating a second noun anticipation using the noun decoder, and combining the first noun anticipation with the second noun anticipation.

17. The system of claim 16, wherein the at least one computer:
determines a first verb anticipation uncertainty that indicates a prediction confidence associated with the first verb anticipation;
determines a second verb anticipation uncertainty that indicates a prediction confidence associated with the second verb anticipation;
determines a first noun anticipation uncertainty that indicates a prediction confidence associated with the first noun anticipation;
determines a second noun anticipation uncertainty that indicates a prediction confidence associated with the second noun anticipation;
combines the first verb anticipation and the second verb anticipation based on the first verb anticipation uncertainty and the second verb anticipation uncertainty, and
combines the first noun anticipation and the second noun anticipation based on the first noun anticipation uncertainty and the second noun anticipation uncertainty.

18. The system of claim 13, wherein the verb anticipation indicates a plurality of verbs associated with the object, the noun anticipation indicates a plurality of nouns associated with the object, and the at least one computer generates the action anticipation to include a verb-noun pair with a verb from the plurality of verbs and a noun from the plurality of nouns.

19. The system of claim 13, further comprising:
a vehicle; and
a camera mounted on the vehicle, wherein the camera generates the video data indicating the vehicle as the object, and indicating a user in the environment with the vehicle,
wherein the at least one computer generates the action anticipation describing an action by the user with respect to the vehicle, and includes an electronic control unit (ECU) that actuates autonomous features of the vehicle based on the action anticipation.

20. A non-transitory computer readable storage medium storing instructions that, when executed by a computer having a processor, causes the processor to perform a method, the method comprising:
receiving video data indicating an object in an environment;
encoding a noun embedding using a noun encoder based on the video data;
encoding a verb embedding with a verb encoder based on the video data;
generating a verb anticipation associated with the object in the environment by processing the noun embedding using a verb decoder;
generating a noun anticipation associated with the object in the environment by processing the verb embedding using a noun decoder; and
generating an action anticipation by combining the verb anticipation and the noun anticipation.
